(19) United States
(12) Patent Application Publication
(10) Pub. No.: US 2023/0198731 A1
(43) Pub. Date: Jun. 22, 2023

(54) TECHNIQUES FOR CONFIGURING SUPPLEMENTARY UPLINK SUPPORT FOR HALF-DUPLEX FDD UE

(71) Applicant: QUALCOMM Incorporated, San Diego, CA (US)

(72) Inventors: Yiqing CAO, Beijing (CN); Jing LEI, San Diego, CA (US); Peter GAAL, San Diego, CA (US); Wanshi CHEN, San Diego, CA (US)

(21) Appl. No.: 17/924,240

(22) PCT Filed: Jun. 26, 2020
(86) PCT No.: PCT/CN2020/098311

§ 371 Date: Nov. 9, 2022

(51) Int. Cl. H04L 5/16; H04W 72/232; H04W 72/0453

(52) U.S. Cl. CPC H04L 5/16; H04W 72/232; H04W 72/0453

(57) ABSTRACT

Aspects of the present disclosure provide techniques configuring half-duplex UEs (HD-UEs) to implement supplementary uplink (SUL) in band combination that may be in same or different frequency range designations (e.g., FR1 or FR2) in both FDD and TDD without the benefit of a duplexer.

### BACKGROUND

The present disclosure relates to wireless communication systems, and more particularly, to techniques for configuring supplementary uplink (SUL) for half-duplex frequency division duplexing (HD-FDD) user equipment (UE).

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as new radio (NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information. As the demand for mobile broadband access continues to increase, however, further improvements in NR communications technology and beyond may be desired.

### SUMMARY

Aspects of the present disclosure provide techniques configuring half-duplex UEs (HD-UEs) to implement supplementary uplink (SUL) in band combination that may be in same or different frequency range (FR) designations (e.g., FR1 or FR2) in both FDD and TDD without the benefit of a duplexer.

In one example, a method for wireless communication is disclosed. The method may include establishing, at a base station, communication with a user equipment (UE), wherein the UE is a half-duplex device that lacks a duplexer. The method may further include generating configuration information for the UE for bidirectional communication by allocating at least an anchor carrier for one or both of downlink and uplink communication and a supplementary uplink (SUL) carrier for uplink communications, wherein the anchor carrier and the SUL carrier is in one of a time division duplex (TDD) band or a frequency division duplex (FDD) band. The method may further include transmitting the configuration information to the UE for the bidirectional communication, wherein the UE switches between uplink and downlink communications in one or both of anchor carrier and SUL carrier based on the configuration information.

In another example, an apparatus for wireless communications. The apparatus may include a memory having instructions and a processor configured to execute the instructions to establish, at a base station, communication with a UE, wherein the UE is a half-duplex device that lacks a duplexer. The processor may further be configured to execute the instructions to generate configuration information for the UE for bidirectional communication by allocating at least an anchor carrier for one or both of downlink and uplink communication and a SUL carrier for uplink communications, wherein the anchor carrier and the SUL carrier is in one of a TDD band or a FDD band. The processor may further be configured to execute the instructions to transmit the configuration information to the UE for the bidirectional communication, wherein the UE switches between uplink and downlink communications in one or both of anchor carrier and SUL carrier based on the configuration information.

In some aspects, a non-transitory computer readable medium includes instructions stored therein that, when executed by a processor, cause the processor to perform the steps of establishing, at a base station, communication with a UE, wherein the UE is a half-duplex device that lacks a duplexer. The processor may further execute the instructions for generating configuration information for the UE for bidirectional communication by allocating at least an anchor carrier for one or both of downlink and uplink communication and a SUL carrier for uplink communications, wherein the anchor carrier and the SUL carrier is in one of a TDD band or a FDD band. The processor may further execute the instructions for transmitting the configuration information to the UE for the bidirectional communication, wherein the UE switches between uplink and downlink communications in one or both of anchor carrier and SUL carrier based on the configuration information.

In certain aspects, another apparatus for wireless communication is disclosed. The apparatus may include means for establishing, at a base station, communication with a UE, wherein the UE is a half-duplex device that lacks a duplexer. The apparatus may further include means for generating configuration information for the UE for bidirectional communication by allocating at least an anchor carrier for one or both of downlink and uplink communication and a SUL carrier for uplink communications, wherein the anchor carrier and the SUL carrier is in one of a TDD band or a FDD band. The apparatus may further include means for transmitting the configuration information to the UE for the bidirectional communication, wherein the UE switches between uplink and downlink communications in one or both of anchor carrier and SUL carrier based on the configuration information.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of an example of a wireless communications system in accordance with aspects of the present disclosure;

FIG. 2 is an example of a timing diagram of the UE switching between DL-to-UL communication (and vice versa) and from NUL-to-SUL communication (and vice versa);

FIG. 3 is a schematic diagram of an example implementation of various components of a base station in accordance with various aspects of the present disclosure; and

FIG. 4 is a flow diagram of an example of a method of wireless communication implemented by the base station in accordance with aspects of the present disclosure.

### DETAILED DESCRIPTION

In recent years, with the introduction of a myriad of smart handheld devices, user demands for mobile broadband has dramatically increased. For example, the drastic growth of bandwidth-hungry applications such as video streaming and multimedia file sharing are pushing the limits of current cellular systems. Much of the focus of addressing such demand has been on traditional smartphones and vertical applications (e.g., vehicle-to-everything (V2X)).

However, in some scenarios, a number of reduced capability (RedCap) and/or internet of things (IoT) devices may also connect to the network. A RedCap device and/or IoT device may be used for several scenarios including wearable devices, industrial wireless sensors, and video surveillance. Some of these scenarios may involve stationary devices and there may be a relatively large number of such devices located within a cell.

The RedCap and IoT devices require a small form factor compared to traditional smartphones. For purposes of this disclosure and unless expressly specified, the terms “RedCap devices” or “IoT devices” may be used interchangeably with “UEs.” The small form factor of RedCap limits the antenna dimension size and radiation efficiency in the device. To further reduce the device costs, a duplexer that is generally integrated in smartphones may be replaced by a switch that is comparably less costly in RedCap/IoT devices.

For reference, a “duplexer” is a hardware device that is integrated in smartphones in order to allow dual-direction communications (e.g., uplink and downlink) concurrently on the same transmission line (e.g., antenna). This is typically achieved through filters that separate the frequencies of interest, allowing signals at two different frequencies to be sent and received from the same antenna. However, as noted above, due to the size and cost constraints, a duplexer may be replaced with a less costly “switch” for RedCap devices. Incorporation of a switch (as opposed to a duplexer) may limit the duplexing mode of RedCap devices and increase the noise that is experienced at the RedCap devices. The loss of antenna efficiency and the increase of noise figure may lead to the degradation of uplink coverage for the RedCap devices.

In order to compensate for the loss of uplink coverage, a HD-FDD UE may be configured to support both SUL and or normal uplink (NUL). Particularly, current 5G NR systems may operate in one or more frequency bands within the electromagnetic spectrum. The electromagnetic spectrum is often subdivided, based on frequency/wavelength, into various classes, bands, channels, etc. In 5G NR, two initial operating bands have been identified as frequency range (FR) designations FR1 (e.g., 410 MHz-7.125 GHz) and FR2 (e.g., 24.25 GHz-52.6 GHz).

Compared to lower frequency bands, higher frequency bands may suffer larger path loss and penetration loss of a signal. This issue is even more severe for the uplink communication due to the higher frequency and smaller portion of the uplink resource allocation. Thus, generally the cell coverage in uplink direction (e.g., from UE to base station) may be lower than the downlink direction (e.g., from base station to UE) in part because the UE Tx Power (i.e., uplink power) is not as strong as the base station transmitter power (i.e., downlink power).

In order to compensate for such degradation, the base station may configure the UEs or RedCap devices to use SUL frequency bands which are lower than the normal uplink (NUL) frequency bands. For example, the UE may be configured to also utilize a SUL carrier in the 1.8 GHz band and utilize a NUL TDD carrier may in the 3.5 GHz band. This is because the cell coverage may be inversely proportional to the frequency bands used for communication (e.g., cell coverage gets larger as frequency gets lower). As such, while the channel conditions between the UE and base station are above a channel quality threshold (e.g., when the UE is closer in distance to the base station), the UE may transmit uplink communication on NUL frequency (e.g., 3.5 GHz band). But as the channel conditions fall below the channel quality threshold, the base station may configure the UE to instead use the SUL (e.g., 1.8 GHz) for uplink communications.

In current 5G NR systems, the additional SUL carrier is limited to time division duplex (TDD) band. However, the RedCap devices may support both TDD and frequency domain duplex (FDD). The TDD refers to duplex communication links where the uplink is separated from downlink by the allocation of different time slots in the same frequency band. In contrast, FDD may reference to the transmitter and receiver that operate using different carrier frequencies. As noted above, in the absence of a duplexer that is replaced with a less costly switch, the duplexing mode capabilities of RedCap devices may be limited.

Aspects of the present disclosure solve the above-identified problem by implementing techniques for configuring half-duplex UEs (HD-UEs) to implement SUL in hand combination that may be in same or different FRs in both FDD and TDD without the benefit of a duplexer. For example, in one scenario, the downlink transmission from the base station to the HD-UE may occur on TDD band of FR1 while the uplink transmission may occur on the SUL or TDD band of FR1. In another scenario, the downlink transmission for HD-UE may occur on the downlink carrier of the FDD band in FR1, while the uplink transmission may occur on SUL of FR1. In yet another scenario, the downlink transmission may occur on TDD band of FR2, while the uplink transmission may occur on SUL of FR1 or TDD band of FR2. In another example, the downlink transmission may occur on TDD band of FR2 and the uplink transmission may occur on uplink carrier of FDD band or TDD band of FR2. In another example, the downlink transmission may occur on TDD band of FR2 or TDD band of FR1, while the uplink transmission may occur on TDD band of FR1 or TDD band of FR2. Finally, in another example, the downlink transmission may occur on a downlink carrier of the FDD band in FR1 and uplink transmission may occur on either the uplink carrier of the FDD in FR1 or the SUL in FR1.

In some aspects, the downlink and uplink bandwidth parts (BWP) configuration for HD-UE may be configured by the base station. BWP enable more flexibility in how resources are assigned in a given carrier. Particularly, BWP enable multiplexing of different signals and signal types for better utilization and adaptation of spectrum and UE power. With BWP, the carrier can be subdivided and used for different purposes. Each 5G NR BWP has its own numerology, meaning that each BWP can be configured differently with its own signal characteristic, enabling more efficient use of the spectrum and more efficient use of power.

In accordance with aspects of the present disclosure, the base station may configure the uplink BWP based on downlink control information (DCI) that is transmitted on a downlink carrier of either the TDD band (FR1 or FR2) or FDD band (FR1). In another example, the BWP may be configured using radio resource control (RRC) signaling on the downlink carrier. In some aspects, the RRC signaling may be dedicated (for a single HD-UE) or a common to a group of HD-UEs. The RRC signaling may be transmitted in the TDD band (e.g., FR1 or FR2) or FDD band (FR1).

The numerology configuration for downlink and uplink BWP may be activated for HD-UE. Particularly, when the downlink and uplink carrier of HD-UE belong to the same FR, the numerology of the DL BWP and the numerology of the uplink BWP may be either same or different. However, when the downlink and uplink carriers of HD-UE belong to different FRs, the numerology of the downlink BWP and the numerology of the uplink BWP may be different.

Additionally, a guard period may be configured when the HD-UE switches from downlink to uplink communication or vice versa. To this end, the design options for the guard period of HD-UE, including for cross-band combination may include the same guard period of Nμ symbols for downlink-to-uplink (DL-to-UL) switching and uplink-to-downlink (UL-to-DL) switching or using a different guard periods for the DL-to-UL as compared to the guard period for the UL-to-DL (e.g., first guard period for DL-to-UL switching and a second guard period for UL-to-DL switching, where the first and second guard periods are different).

In the first scenario of using the same guard period for both DL-to-UL and UL-to-DL switching, the guard period of Nμ may be a function of the minimum subcarrier spacing (SCS) of the active downlink BWP and the active uplink BWP (e.g., μ=(SCS_{UL-BWP}, SCS_{DL-BWP}). In some examples, the value of Nμ may be either hard coded in the specification, or indicated in system information block (SIB) as part of the system information. This may include reusing the HD Tx-Rx switching time and choosing the larger one if the FRs of downlink and uplink are different. Alternatively, the BWP switching gap may be reused based on the SCS specific value.

In the second scenario where the guard periods are different for DL-to-UL and UL-to-DL switching, the DL-to-UL switching may utilize a guard period of Nμ symbols and the UL-to-DL switching may utilize the guard period of Nμ−Δ A symbols (where 0<Δ<Nμ). In such scenario, the value of Δ may be either hard coded in the specification or indicated in SIB, which depends on the FR and/or the SCS of uplink and downlink BWPs. Thus, the guard period for the DL-to-UL may be longer than guard periods when switching from UL-to-DL. In some aspects, the UE may also report the switching time via capability signaling, including reporting either one or both of Nμ and Δ values to the base station.

The location of the guard (e.g., which carrier and which symbol) may also be configured. For example, with respect to DL-to-UL switching, when the uplink transmission is on a TDD band, the guard location may be configured on the uplink carrier which either fully or partially overlaps with the downlink or flexible symbols of the uplink carrier). However, when the uplink transmission is on a FDD band, the guard location may be configured on either the downlink or uplink carrier. With respect to the UL-to-DL switching, when the downlink transmission is on a TDD band, the guard location is configured on the downlink carrier, which is fully or partially overlap with the uplink symbols of the downlink carrier. However, when the downlink transmission is on a FDD band, the guard location can again be configured on either the downlink or uplink carrier

In some aspects, slot and symbol repetition may be allowed to increase the transmission reliability. This may include joint configuration of repetition where, for example, 8 repetitions of transmissions could be subdivided such that 6 transmissions occur on NUL and 2 on SUL (or vice versa). The repetition transmission resources may be on the same symbol or frequency configuration. If the repetition is interrupted on one of the NUL/SUL, the UE may restart the repetition on the new component carrier (CC), or the UE may complete the rest of the repetition numbers on the new CC if channel grant (CG) resources are available. In another alternative, once the repetition is interrupted, the UE may recognize the interruption as an error case and abandon further uplink transmission.

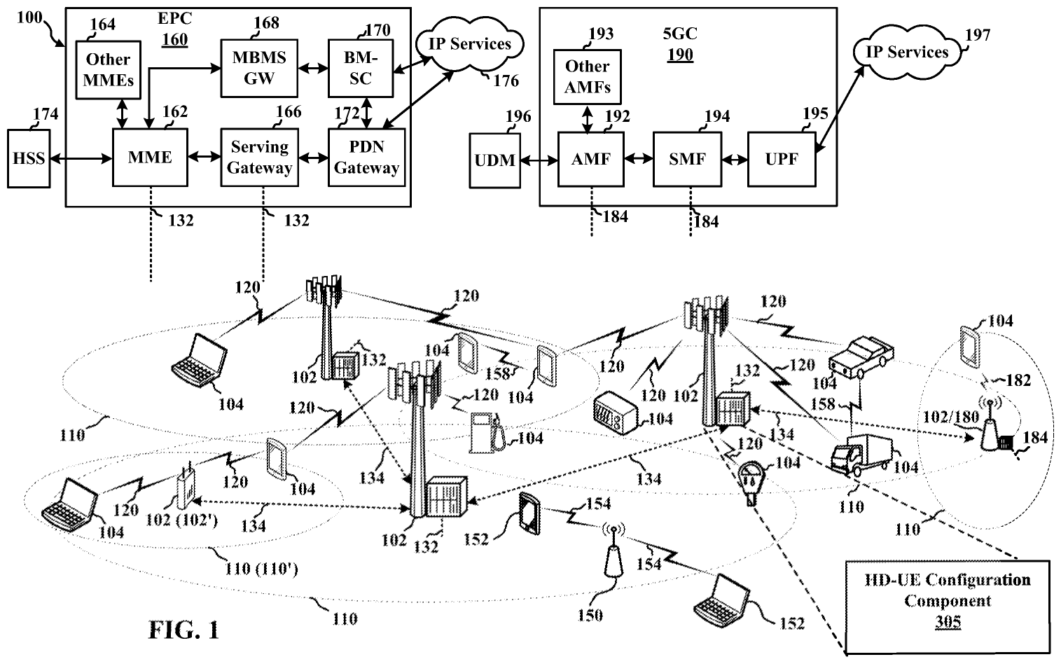

Various aspects are now described in more detail with reference to the FIGS. 1-4. In the following description, for purposes of explanation, numerous specific details are set forth in order to provide a thorough understanding of one or more aspects. It may be evident, however, that such aspect(s) may be practiced without these specific details. Additionally, the term “component” as used herein may be one of the parts that make up a system, may be hardware, firmware, and/or software stored on a computer-readable medium, and may be divided into other components.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem and a HD-UE configuration component 305 for configuring HD-UEs to implement SUL in band combination that may be in same or different FRs in both FDD and TDD without the benefit of a duplexer, in accordance with aspects described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate one or more frequency bands within the electromagnetic spectrum. The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 110 to compensate for the path loss and short range.

base station 102 referred to herein can include a gNB 180. The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In an example, the full-duplex communication component 350 can receive a DCI transmission to facilitate a multi-beam full-duplex communication. The full-duplex communication component 350 may also decode the DCI to identify one or more beams from a plurality of candidate beams to be used for the multi-beam full-duplex communication by the first UE. In some examples, the multi-beam full-duplex communication may include the first UE contemporaneously transmitting uplink communication over at least a first beam and receiving downlink communication over at least a second beam on a same frequency band. Further, the fill-duplex communication component 350 may transmit, during a first time slot, uplink data over a first set of antennas of the UE to a base station or a second UE on at least the first beam identified based on the decoding of the DCI. The full-duplex communication component 350 may also receive, during a first time slot, downlink data over a second set of antennas of the UE from the base station or the second UE on the at least the second beam identified based on the decoding of the DCI.

Similarly, one or more base stations (e.g., gNBs 102) or UEs 104 (e.g., for sidelink communication) may generate a DCI in accordance with aspects of the present disclosure and signal the full-duplex capabilities and beam assignments for uplink and downlink concurrent communication on the same frequency band.

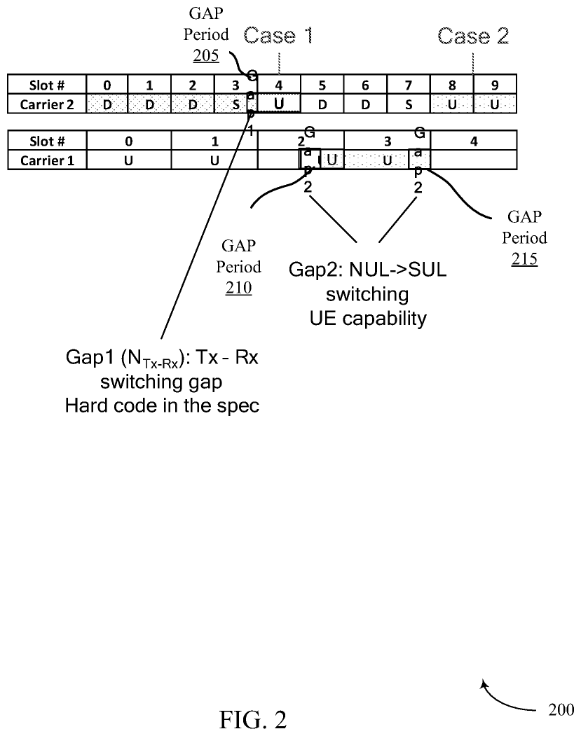

FIG. 2 is an example of a timing diagram 200 of the UE switching between DL-to-UL communication (and vice versa) and from NUL-to-SUL communication (and vice versa). As illustrated, the UE may switch from DL-to-UL communication in the same carrier (as shown on “Carrier 2” slots 2-4) and between the two carriers from NUL (slot 4) to SUL (slot no. 2 in “Carrier 1”). The UE may also switch back from SUL-to-NUL, as shown in slot no. 3 of Carrier 1 to slot no. 8 of Carrier 2.

In some aspects, a guard period (e.g., gap period 205) may be configured when the HD-UE switches from downlink to uplink communication or vice versa and/or from NUL-to-SUL (e.g., gap periods 210 and 215). As noted above, the design options for the guard period of HD-UE, including for cross-band combination may include the same guard period of Nμ symbols for downlink-to-uplink (DL-to-UL) switching and uplink-to-downlink (UL-to-DL) switching or using a different guard periods for the DL-to-UL as compared to the guard period for the UL-to-DL (e.g., first guard period for DL-to-UL switching and a second guard period for UL-to-DL switching, where the first and second guard periods are different).

In the first scenario of using the same guard period for both DL-to-UL and UL-to-DL switching, the guard period of Nμ may be a function of the minimum SCS of the active downlink BWP and the active uplink BWP (e.g., μ=min (SCS_{UL-BWP}, SCS_{DL-BWP})). In some examples, the value of Nμ may be either hard coded in the specification, or indicated in SIB as part of the system information. This may include reusing the HD Tx-Rx switching time and choosing the larger one if the FRs of downlink and uplink are different. Alternatively, the BWP switching gap may be reused based on the SCS specific value.

In the second scenario where the guard periods are different for DL-to-UL and UL-to-DL switching, the DL-to-UL switching may utilize a guard period of Nμ symbols and the UL-to-DL switching may utilize the guard period of Nμ−Δ symbols (where 0<Δ<Nμ). In such scenario, the value of Δ may be either hard coded in the specification or indicated in SIB, which depends on the FR and/or the SCS of uplink and downlink BWPs. In some aspects, the UE may also report the switching time via capability signaling, including reporting either one or both of Nμ and Δ values to the base station.

The location of the guard period (e.g., which carrier and which symbol) may also be configured. For example, with respect to DL-to-UL switching, when the uplink transmission is on a TDD carrier, the guard period may be configured on the uplink carrier which either fully or partially overlaps with the downlink or flexible symbols of the uplink carrier). However, when the uplink transmission is on a FDD carrier, the guard period may be configured on either the downlink or uplink carrier. With respect to the UL-to-DL switching, when the downlink transmission is on a TDD carrier, the guard period is configured on the downlink carrier, which is fully or partially overlap with the uplink symbols of the downlink carrier. However, when the downlink transmission is on a FDD carrier, the guard period can again be configured on either the downlink or uplink carrier

In some aspects, slot and symbol repetition may be allowed to increase the transmission reliability. This may include joint configuration of repetition where, for example, 8 repetitions of transmissions could be subdivided such that 6 transmissions occur on NUL and 2 transmissions on SUL (or vice versa). The repetition transmission resources may be on the same symbol or frequency configuration. If the repetition interrupted on one of the NUL/SUL, the UE may restart the repetition on the new component carrier (CC), or the UE may complete the rest of the repetition numbers on the new CC if channel grant (CG) resources are available. In another alternative, once the repetition is interrupted, the UE may recognize the interruption as an error case and abandon further uplink transmission.

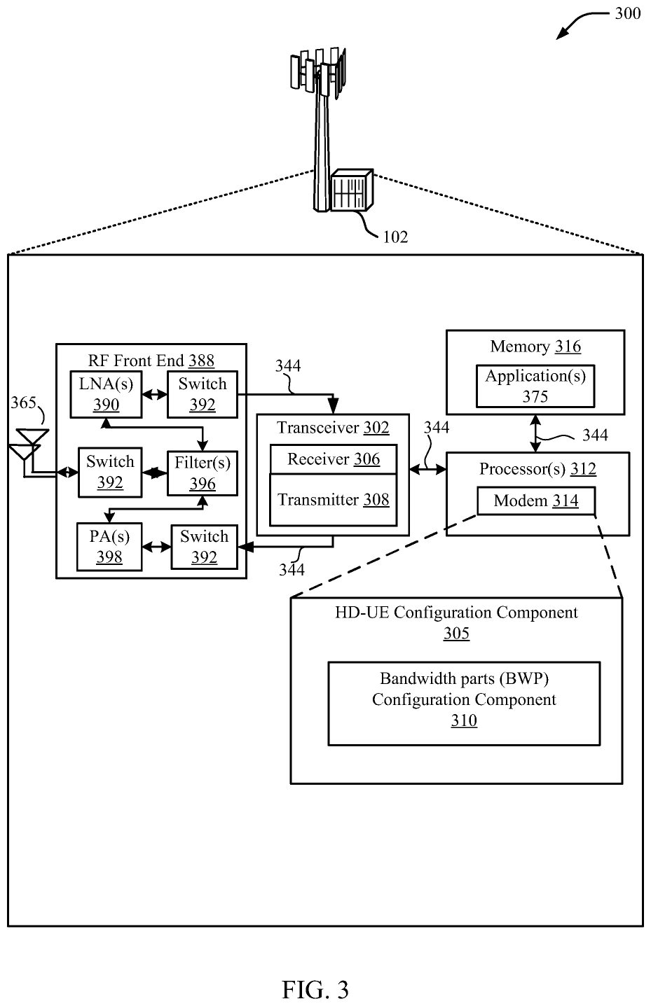

FIG. 3 illustrates a hardware components and subcomponents of a base station 102 for implementing one or more methods (e.g., method 400) described herein in accordance with various aspects of the present disclosure. For example, one example of an implementation of the base station 102 may include a variety of components, some of which have already been described above, but including components such as one or more processors 312, memory 316 and transceiver 302 in communication via one or more buses 344, which may operate in conjunction with the HD-UE configuration component 305 to perform functions described herein related to including one or more methods (e.g., 400) of the present disclosure.

In some aspects, the HD-UE configuration component 305 can configure HD-UEs to implement SUL in band combination that may be in same or different FRs in both FDD and TDD without the benefit of a duplexer. For example, in one scenario, the downlink transmission from the base station to the HD-UE may occur on TDD band of FR1 while the uplink transmission may occur on the SUL or TDD band of FR1. In another scenario, the downlink transmission for HD-UE may occur on the downlink carrier of the FDD band in FR1, while the uplink transmission may occur on SUL of FR1. In yet another scenario, the downlink transmission may occur on TDD hand of FR2, while the uplink transmission may occur on SUL of FR1 or TDD hand of FR2. In another example, the downlink transmission may occur on TDD band of FR2 and the uplink transmission may occur on uplink carrier of FDD band or TDD band of FR2. In another example, the downlink transmission may occur on TDD band of FR2 or TDD band of FR1, while the uplink transmission may occur on TDD band of FR1 or TDD band of FR2. Finally, in another example, the downlink transmission may occur on a downlink carrier of the FDD band in FR1 and uplink transmission may occur on either the uplink carrier of the FDD in FR1 or the SUL in FR1.

Additionally, in some aspects, the downlink and uplink BWP configuration for HD-UE may be configured by the HD-UE configuration component 305, and more particularly the BWP configuration component 310 of the base station 102. In accordance with aspects of the present disclosure, the HD-UE configuration component 305 may configure the uplink BWP based on downlink control information (DCI) that is transmitted on a downlink carrier of either the TDD band (FR1 or FR2) or FDD band (FR1). In another example, the BWP may be configured using radio resource control (RRC) signaling on the downlink carrier. In some aspects, the RRC signaling may be dedicated (for a single HD-UE) or a common to a group of HD-UEs. The RRC signaling may be transmitted in the TDD hand (e.g., FR1 or FR2) or FDD band (FR1).

The numerology configuration for downlink and uplink BWP may be activated for HD-UE. Particularly, when the downlink and uplink carrier of HD-UE belong to the same FR, the numerology of the DL BWP and the numerology of the uplink BWP may be either same or different. However, when the downlink and uplink carriers of HD-UE belong to different FR, the numerology of the downlink BWP and the numerology of the uplink BWP may be different.

The one or more processors 312, modem 314, memory 316, transceiver 302, RF front end 388 and one or more antennas 365, may be configured to support voice and/or data calls (simultaneously or non-simultaneously) in one or more radio access technologies. In an aspect, the one or more processors 312 can include a modem 314 that uses one or more modem processors. The various functions related to full-duplex communication management component 350 may be included in modem 314 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 314 associated with communication management component 350 may be performed by transceiver 302.

The memory 316 may be configured to store data used herein and/or local versions of application(s) 375 or the HD-UE configuration component 305 and/or one or more of its subcomponents being executed by at least one processor 312. The memory 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, the memory 316 may be a non-transitory computer-readable storage medium that stores one or more computer-executable codes defining the HD-UE configuration component 305 and/or one or more of its subcomponents, and/or data associated therewith, when the base station 102 is operating at least one processor 312 to execute the HD-UE configuration component 305 and/or one or more of its subcomponents.

The transceiver 302 may include at least one receiver 306 and at least one transmitter 308. The receiver 306 may include hardware, firmware, and/or software code executable by a processor for receiving data, the code comprising instructions and being stored in a memory (e.g., computer-readable medium). The receiver 306 may be, for example, a radio frequency (RF) receiver. In an aspect, the receiver 306 may receive signals transmitted by at least one UE 104. Additionally, receiver 306 may process such received signals, and also may obtain measurements of the signals, such as, but not limited to, Ec/Io, SNR, RSRP, RSSI, etc. The transmitter 308 may include hardware, firmware, and/or software code executable by a processor for transmitting data, the code comprising instructions and being stored in a memory (e.g., computer-readable medium). A suitable example of the transmitter 308 may including, but is not limited to, an RF transmitter.

Moreover, in an aspect, transmitting device may include the RF front end 388, which may operate in communication with one or more antennas 365 and transceiver 302 for receiving and transmitting radio transmissions, for example, wireless communications transmitted by at least one base station 102 or wireless transmissions transmitted by UE 104. The RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In an aspect, the LNA 390 can amplify a received signal at a desired output level. In an aspect, each LNA 390 may have a specified minimum and maximum gain values. In an aspect, the RF front end 388 may use one or more switches 392 to select a particular LNA 390 and its specified gain value based on a desired gain value for a particular application.

Further, for example, one or more PA(s) 398 may be used by the RF front end 388 to amplify a signal for an RF output at a desired output power level. In an aspect, each PA 398 may have specified minimum and maximum gain values. In an aspect, the RF front end 388 may use one or more switches 392 to select a particular PA 398 and its specified gain value based on a desired gain value for a particular application.

Also, for example, one or more filters 396 can be used by the RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, the RF front end 388 can use one or more switches 392 to select a transmit or receive path using a specified filter 396, LNA 390, and/or PA 398, based on a configuration as specified by the transceiver 302 and/or processor 312.

As such, the transceiver 302 may be configured to transmit and receive wireless signals through one or more antennas 365 via the RF front end 388. In an aspect, the transceiver 302 may be tuned to operate at specified frequencies such that transmitting device can communicate with, for example, one or more UEs 104 or one or more cells associated with one or more base stations 102. In an aspect, for example, the modem 314 can configure the transceiver 302 to operate at a specified frequency and power level based on the configuration of the transmitting device and the communication protocol used by the modem 314.

In an aspect, the modem 314 can be a multiband-multimode modem, which can process digital data and communicate with the transceiver 302 such that the digital data is sent and received using the transceiver 302. In an aspect, the modem 314 can be multiband and be configured to support multiple frequency bands for a specific communications protocol. In an aspect, the modem 314 can be multimode and be configured to support multiple operating networks and communications protocols. In an aspect, the modem 314 can control one or more components of transmitting device (e.g., RF front end 388, transceiver 302) to enable transmission and/or reception of signals from the network based on a specified modem configuration. In an aspect, the modem configuration can be based on the mode of the modem 314 and the frequency band in use. In another aspect, the modem configuration can be based on base station configuration information associated with transmitting device as provided by the network during cell selection and/or cell reselection.

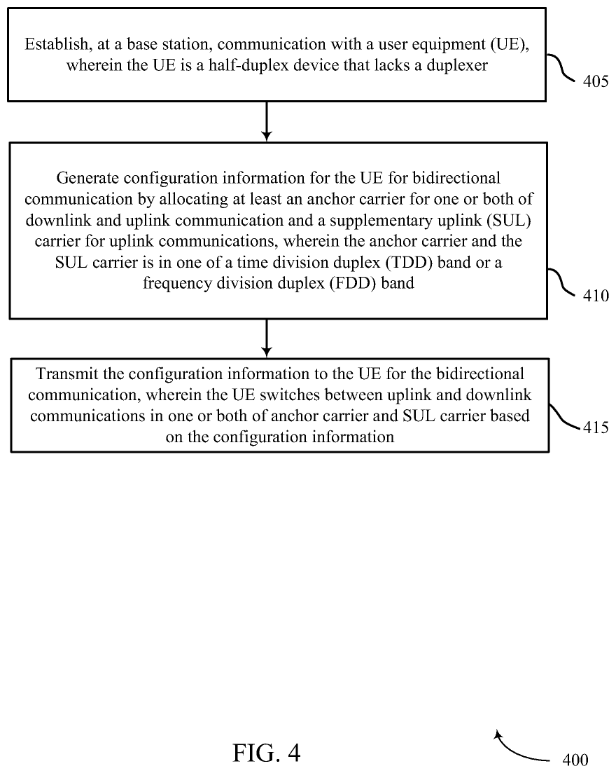

Referring to FIG. 4, an example method 400 for wireless communications in accordance with aspects of the present disclosure may be performed by one or more base stations 102 discussed with reference to FIG. 1. Although the method 400 is described below with respect to the elements of the base station 102, other components may be used to implement one or more of the steps described herein.

At block 405, the method 400 may include establishing, at a base station, communication with a user equipment (UE). In some examples, the UE may be a half-duplex device (e.g., RedCap or IoT device) that lacks a duplexer. Indeed, instead of a duplexer, the UE may include a switch to enable the UE to switch between the uplink and downlink communications and/or NUL-to-SUL and vice versa. Aspects of block 405 may be performed by the transceiver 302 that receives the communication from a UE 104 over one or more antennas 365 as described with reference to FIG. 3. Thus, the transceiver 302, HD-UE configuration component 350, modem 314, processor 312, and/or the base station 102 or one of its subcomponents may define the means for establishing, at a base station, communication with a UE.

At block 410, the method 400 may include generating configuration information for the UE for bidirectional communication by allocating at least an anchor carrier for one or both of downlink and uplink communication and a supplementary uplink (SUL) carrier for uplink communications. In some examples, the anchor carrier and the SUL carrier may be in one of a time division duplex (TDD) band or a frequency division duplex (FDD) band. Aspects of block 410 may be performed by the HD-UE configuration component 350 as described with reference to FIG. 3. Thus, HD-UE configuration component 350, modem 314, processor 312, and/or the base station 102 or one of its subcomponents may define the means for generating configuration information for the UE for bidirectional communication by allocating at least an anchor carrier for one or both of downlink and uplink communication and a SUL carrier for uplink communications.

In some aspects, generating the configuration information may include configuring the downlink transmission from the base station to the HD-UE that may occur on TDD band of FR1 while the uplink transmission may occur on the SUL or TDD band of FR1. For example, the method may include configuring the downlink transmission from the base station to the UE on the anchor carrier in the TDD band of frequency range 1 (FR1), wherein the FR1 includes a frequency range of 410 MHz-7.125 GHz of an electromagnetic spectrum, and configuring uplink transmission on the SUL carrier or the TDD of FR1.

In another scenario, the downlink transmission for HD-UE may occur on the downlink carrier of the FDD band in FR1, while the uplink transmission may occur on SUL of FR1. For example, the method may include configuring downlink transmission from the base station to the UE on the anchor carrier in the FDD band of frequency range 1 (FR1), wherein the FR1 includes a frequency range of 410 MHz-7.125 GHz of an electromagnetic spectrum, and configuring uplink transmission on the SUL carrier in the FDD band of FR1.

In yet another scenario, the downlink transmission may occur on TDD band of FR2, while the uplink transmission may occur on SUL of FR1 or TDD band of FR2. For example, the method may include configuring downlink transmission from the base station to the UE on the anchor carrier in the TDD band of frequency range 2 (FR2), wherein the FR2 includes a frequency range of 24.25 GHz-52.6 GHz of an electromagnetic spectrum, and configuring uplink transmission on the SUL carrier of FR1 or the TDD band of the FR2.

In another example, the downlink transmission may occur on TDD band of FR2 and the uplink transmission may occur on uplink carrier of FDD band or TDD band of FR2. In some examples, the method may include configuring downlink transmission from the base station to the UE on the anchor carrier in the TDD band of frequency range 2 (FR2), wherein the FR2 includes a frequency range of 24.25 GHz-52.6 GHz of an electromagnetic spectrum, and configuring uplink transmission on the FDD band or the TDD hand of the FR2.

In another example, the downlink transmission may occur on TDD band of FR2 or TDD band of FR1, while the uplink transmission may occur on TDD band of FR1 or TDD band of FR2. In some examples, the method may include configuring downlink transmission from the base station to the UE on the anchor carrier in the TDD band of frequency range 2 (FR2) or the TDD band of frequency range 1 (FR1), wherein the FR1 includes a frequency range of 410 MHz-7.125 GHz and the FR2 includes the frequency range of 24.25 GHz-52.6 GHz of an electromagnetic spectrum, and configuring uplink transmission on the TDD band the FR1 or the FR2.

In another example, the downlink transmission may occur on a downlink carrier of the FDD band in FR1 and uplink transmission may occur on either the uplink carrier of the FDD in FR1 or the SUL in FR1. In some examples, the method may include configuring downlink transmission from the base station to the UE on the anchor carrier in the FDD band of frequency range 1 (FR1), wherein the FR1 includes a frequency range of 410 MHz-7.125 GHz of an electromagnetic spectrum, and configuring uplink transmission on either an uplink carrier of the FDD band in FR1 or the SUL carrier in FR1.

Additionally or alternatively, generating the configuration information may include configuring an uplink bandwidth part (BWP) based on downlink control information (DCI) that is transmitted on a downlink carder of either the TDD band in one of frequency range 1 (FR1) or frequency range 2 (FR2) or the FDD band in the FR1, wherein the FR1 includes a frequency range of 410 MHz-7.125 GHz and the FR2 includes the frequency range of 24.25 GHz-52.6 GHz of an electromagnetic spectrum.

In some aspects, generating the configuration information may include configuring an uplink BWP using RRC signaling on the downlink carrier, wherein the RRC is either dedicated for the UE or for a group of UEs, wherein the RRC signaling is transmitted in the TDD band in one of frequency range 1 (FR1) or frequency range 2 (FR2) or the FDD band in the FR1.

In some examples, the method 400 may include determining one or both of a guard period or guard location for when the UE switches between the uplink and downlink communications in one or both of the anchor carrier and the SUL carrier based on the configuration information. The guard period of Nμ symbols for bath an uplink-to-downlink (UL-to-DL) switch and downlink-to-uplink (DL-to-UP) switch may be determined based on a function of a minimum subcarrier spacing (SCS) of an active downlink bandwidth part (BWP) and an active uplink BWP. In other examples, the guard period of symbols for downlink-to-uplink (DL-to-UP) switch may be determined based on a function of a minimum subcarrier spacing (SCS) of an active downlink bandwidth part (BWP) and an active uplink BWP. Additionally, the guard period for an uplink-to-downlink (UL-to-DL) switch may be a value that is Nμ symbols less a delta (Δ) value, wherein the delta (Δ) value is greater than zero and less than the Nμ symbols.

In some examples, the guard location may also be determined when the UE switches between UL-to-DL or DL-to-UL in either NUL or SUL. Particularly, identifying the location of the guard may include configuring the guard location on an uplink carrier of the TDD band when the UE is to perform downlink-to-uplink (DL-to-UP) switch. In other examples, the guard location may be on either a downlink or an uplink carrier when the uplink transmission is on the FDD band when the UE performs downlink-to-uplink (DL-to-UP) switching. Additionally, in some aspects, the guard location may be configured on a downlink carrier when the downlink transmission is on the TDD band when the UE performs UL-to-DL switching. In other scenarios, the guard location may be configured on either a downlink carrier or an uplink carrier when the downlink transmission is on the FDD band when the UE performs UL-to-DL switching.

At block 415, the method 400 may include transmitting the configuration information to the UE for the bidirectional communication, wherein the UE switches between uplink and downlink communications in one or both of anchor carrier and SUL carrier based on the configuration information. Aspects of block 415 may be performed by the transceiver 302 that transmits communication to a UE 104 over one or more antennas 365 as described with reference to FIG. 3. Thus, the transceiver 302, HD-UE configuration component 350, modem 314, processor 312, and/or the base station 102 or one of its subcomponents may define the means for transmitting the configuration information to the UE for the bidirectional communication, wherein the UE switches between uplink and downlink communications in one or both of anchor carrier and SUL carrier based on the configuration information.

In some examples, the method may also include receiving, at the base station, repetition transmissions from the UE over a plurality of slots, wherein the repetition transmissions are in one or both of a normal uplink (NUL) carrier or the SUL carrier. The method may include detecting an interruption of the repetition transmission from the UE, and receiving on a new component carrier the repetition transmissions from the UE that are restarted. The method may also include detecting an interruption of the repetition transmission from the UE, and receiving on a new component carrier a portion of the repetition transmissions from the UE that had been interrupted. In some examples, the method may also include detecting an interruption of the repetition transmission from the UE, wherein the UE abandons transmissions of remaining portion of the repetition transmission that was interrupted.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above may be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that may be accessed by a general purpose or special purpose computer. By way of example, and not limitation, computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The detailed description set forth above in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems are also presented with reference to various apparatus and methods. These apparatus and methods are described in the detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout the disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM), An OFDMA system may implement a radio technology such as Ultra Mobile Broadband (UMB), Evolved UTRA (E-UTRA), IEEE 902.11 (Wi-Fi), IEEE 902.16 (WiMAX), IEEE 902.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A and/or 5G New Radio (NR) system for purposes of example, and LTE or 5G NR terminology is used in much of the description below, although the techniques are applicable beyond LTE/LTE-A and 5G NR applications, e.g., to other next generation communication systems).

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. A method for wireless communications, comprising:
establishing, at a base station, communication with a user equipment (UE), wherein the UE is a half-duplex device that lacks a duplexer;
generating configuration information for the UE for bidirectional communication by allocating at least an anchor carrier for one or both of downlink and uplink communication and a supplementary uplink (SUL) carrier for uplink communications, wherein the anchor carrier and the SUL carrier are in at least one of a time division duplex (TDD) band or a frequency division duplex (FDD) band; and
transmitting the configuration information to the UE for the bidirectional communication, wherein the UE switches between uplink and downlink communications in one or both of the anchor carrier and the SUL carrier based on the configuration information.

2. The method of claim 1, wherein generating the configuration information for the UE for bidirectional communication, comprises:
configuring downlink transmission from the base station to the UE on the anchor carrier in the TDD band of frequency range 1 (FR1), wherein the FR1 includes a frequency range of 410 MHz-7.125 GHz of an electromagnetic spectrum; and
configuring uplink transmission on the SUL carrier or the TDD of FR1.

3. The method of claim 1, wherein generating the configuration information for the UE for bidirectional communication, comprises:
configuring downlink transmission from the base station to the UE on the anchor carrier in the FDD band of frequency range 1 (FR1), wherein the FR1 includes a frequency range of 410 MHz-7.125 GHz of an electromagnetic spectrum; and
configuring uplink transmission on the SUL carrier in the FDD band of FR1.

4. The method of claim 1, wherein generating the configuration information for the UE for bidirectional communication, comprises:
configuring downlink transmission from the base station to the UE on the anchor carrier in the TDD band of frequency range 2 (FR2), wherein the FR2 includes a frequency range of 24.25 GHz-52.6 GHz of an electromagnetic spectrum; and
configuring uplink transmission on the SUL carrier of FR1 or the TDD band of the FR2.

5. The method of claim 1, wherein generating the configuration information for the UE for bidirectional communication, comprises:
configuring downlink transmission from the base station to the UE on the anchor carrier in the TDD band of frequency range 2 (FR2), wherein the FR2 includes a frequency range of 24.25 GHz-52.6 GHz of an electromagnetic spectrum; and
configuring uplink transmission on the FDD band or the TDD band of the FR2.

6. The method of claim 1, wherein generating the configuration information for the UE for bidirectional communication, comprises:
configuring downlink transmission from the base station to the UE on the anchor carrier in the TDD band of frequency range 2 (FR2) or the TDD band of frequency range 1 (FR1), wherein the FR1 includes a frequency range of 410 MHz-7.125 GHz and the FR2 includes the frequency range of 24.25 GHz-52.6 GHz of an electromagnetic spectrum; and
configuring uplink transmission on the TDD band the FR1 or the FR2.

7. The method of claim 1, wherein generating the configuration information for the UE for bidirectional communication, comprises:
configuring downlink transmission from the base station to the UE on the anchor carrier in the FDD band of frequency range 1 (FR1), wherein the FR1 includes a frequency range of 410 MHz-7.125 GHz of an electromagnetic spectrum; and
configuring uplink transmission on either an uplink carrier of the FDD band in FR1 or the SUL carrier in FR1.

8. The method of claim 1, wherein generating the configuration information for the UE for bidirectional communication, comprises:
configuring an uplink bandwidth part (BWP) based on downlink control information (DCI) that is transmitted on a downlink carrier of either the TDD band in one of frequency range 1 (FR1) or frequency range 2 (FR2) or the FDD band in the FR1, wherein the FR1 includes a frequency range of 410 MHz-7.125 GHz and the FR2 includes the frequency range of 24.25 GHz-52.6 GHz of an electromagnetic spectrum.

9. The method of claim 1, wherein generating the configuration information for the UE for bidirectional communication, comprises:
configuring an uplink bandwidth part (BWP) using radio resource control (RRC) signaling on the downlink carrier, wherein the RRC is either dedicated for the UE or for a group of UEs, and
wherein the RRC signaling is transmitted in the TDD band in one of frequency range 1 (FR1) or frequency range 2 (FR2) or the FDD band in the FR1, wherein the FR1 includes a frequency range of 410 MHz-7.125 GHz and the FR2 includes the frequency range of 24.25 GHz-52.6 GHz of an electromagnetic spectrum.

10. The method of claim 1, wherein generating the configuration information for the UE for bidirectional communication, comprises:
determining one or both of a guard period or guard location for when the UE switches between the uplink and downlink communications in one or both of the anchor carrier and the SUL carrier based on the configuration information.

11. The method of claim 10, wherein the guard period of Mt symbols for both an uplink-to-downlink (UL-to-DL) switch and downlink-to-uplink (DL-to-UP) switch is determined based on a function of a minimum subcarrier spacing (SCS) of an active downlink bandwidth part (BWP) and an active uplink BWP.

12. The method of claim 10, wherein the guard period of Mt symbols for downlink-to-uplink (DL-to-UP) switch is determined based on a function of a minimum subcarrier spacing (SCS) of an active downlink bandwidth part (BWP) and an active uplink BWP, and
wherein the guard period for an uplink-to-downlink (UL-to-DL) switch is a value that is Nμ symbols less a delta (Δ) value, wherein the delta (μ) value is greater than zero and less than the Nμ symbols.

13. The method of claim 10, wherein determining the guard location for when the UE switches, comprises:
configuring the guard location on an uplink carrier of the TDD band when the UE is to perform downlink-to-uplink (DL-to-UP) switch.

14. The method of claim 10, wherein determining the guard location for when the UE switches, comprises:
configuring the guard location on either a downlink or an uplink carrier when the uplink transmission is on the FDD band when the UE performs downlink-to-uplink (DL-to-UL) switching.

15. The method of claim 10, wherein determining the guard location for when the UE switches, comprises:
configuring the guard location on a downlink carrier when the downlink transmission is on the TDD band when the UE performs UL-to-DL switching.

16. The method of claim 10, wherein determining the guard location for when the UE switches, comprises:
configuring the guard location on either a downlink carrier or an uplink carrier when the downlink transmission is on the FDD band when the UE performs UL-to-DL switching.

17. The method of claim 1, further comprising:
receiving, at the base station, a repetition transmissions from the UE over a plurality of slots, wherein the repetition transmissions are in one or both of a normal uplink (NUL) carrier or the SUL carrier.

18. The method of claim 17, further comprising:
detecting an interruption of the repetition transmission from the UE; and
receiving on a new component carrier the repetition transmissions from the UE that are restarted.

19. The method of claim 17, further comprising:
detecting an interruption of the repetition transmission from the UE; and
receiving on a new component carrier a portion of the repetition transmissions from the UE that had been interrupted.

20. The method of claim 17, further comprising:
detecting an interruption of the repetition transmission from the UE, wherein the UE abandons transmissions of remaining portion of the repetition transmission that was interrupted.

21. An apparatus for wireless communications, comprising:
a memory configured to store instructions;
a processor communicatively coupled with the memory, the processor configured to execute the instructions to:
establish, at a base station, communication with a user equipment (UE), wherein the UE is a half-duplex device that lacks a duplexer;
generate configuration information for the UE for bidirectional communication by allocating at least an anchor carrier for one or both of downlink and uplink communication and a supplementary uplink (SUL) carrier for uplink communications, wherein the anchor carrier and the SUL carrier are in at least one of a time division duplex (TDD) band or a frequency division duplex (FDD) band; and
transmit the configuration information to the UE for the bidirectional communication, wherein the UE switches between uplink and downlink communications in one or both of anchor carrier and SUL carrier based on the configuration information.

22. (canceled)

23. A non-transitory computer readable medium storing instructions, executable by a processor, for wireless communications, comprising instructions for:
establishing, at a base station, communication with a user equipment (UE), wherein the UE is a half-duplex device that lacks a duplexer;
generating configuration information for the UE for bidirectional communication by allocating at least an anchor carrier for one or both of downlink and uplink communication and a supplementary uplink (SUL) carrier for uplink communications, wherein the anchor carrier and the SUL carrier are in at least one of a time division duplex (TDD) band or a frequency division duplex (FDD) band; and
transmitting the configuration information to the UE for the bidirectional communication, wherein the UE switches between uplink and downlink communications in one or both of anchor carrier and SUL carrier based on the configuration information.

24. (canceled)

25. An apparatus for wireless communications, comprising:
means for establishing, at a base station, communication with a user equipment (UE), wherein the UE is a half-duplex device that lacks a duplexer;
means for generating configuration information for the UE for bidirectional communication by allocating at least an anchor carrier for one or both of downlink and uplink communication and a supplementary uplink (SUL) carrier for uplink communications, wherein the anchor carrier and the SUL carrier are in at least one of a time division duplex (TDD) band or a frequency division duplex (FDD) band; and
means for transmitting the configuration information to the UE for the bidirectional communication, wherein the UE switches between uplink and downlink communications in one or both of anchor carrier and SUL carrier based on the configuration information.

26. (canceled)
